(19) United States
(12) Patent Application Publication
(10) Pub. No.: US 2007/0199590 A1
(43) Pub. Date: Aug. 30, 2007

(54) Roof Tile-Integrated Solar Battery Module

(76) Inventors: Masao Tanaka, Tondabayashi-shi (JP); Hiroshi Aihara, Higashiosaka-shi (JP)

Correspondence Address: NIXON & VANDERHYE, PC, 901 NORTH GLEBE ROAD, 11TH FLOOR, ARLINGTON, VA, 22203, US

(21) Appl. No.: 11/578,050

(22) PCT Filed: Mar. 29, 2005
(86) PCT No.: PCT/JP05/05807

§ 371 Date: Oct. 12, 2006

(30) Foreign Application Priority Data
Apr. 14, 2004 (JP) 2004-119079

(51) Int. Cl. H02N 6/00

(52) U.S. Cl. 136/251

(57) ABSTRACT

A roof tile-integrated solar battery module applicable to many types of roof tiles can be obtained. A roof tile-integrated solar battery module according to the present invention is a module including a solar battery power generating body, and an exterior member accommodating the solar battery power generating body therein and including an upper metal plate and a lower metal plate. A concave portion formed of an upper metal plate insertion portion and a surface of the upper metal plate and opening in a direction to an eaves when the module is provided at a roof, and a fitting portion for connection, for connecting to another module adjacent in a direction intersecting the direction to the eaves, are formed at the upper metal plate. An eaves side insertion portion extending in a direction to a ridge when the module is provided at the roof is formed at the lower metal plate.

### TECHNICAL FIELD

The present invention relates to a roof tile-integrated solar battery module, and more particularly to a roof tile-integrated solar battery module adaptable to many types of roof tiles.

### BACKGROUND ART

A solar battery cell holding roof tile provided at a roof has conventionally been known (e.g. see Japanese Patent Laying-Open No. 11-107453).

Patent Document 1: Japanese Patent Laying-Open No. 11-107453

### DISCLOSURE OF THE INVENTION

### Problems to be Solved by the Invention

In the Patent Document 1 above, a solar battery cell holding roof tile, which serves as a roof tile-integrated solar battery module, is formed such that the solar battery holding roof tile has an outer dimension similar to that of a single roof tile, or that of a plurality of roof tiles arranged on a roof base material. In other words, in Patent Document 1 above, standardization of the roof tiles at all the planes of the roof is an absolute requirement, and hence the shape and size of the solar battery cell holding roof tile is determined to adapt to the roof tile preliminarily defined. Accordingly, as to a roof that has already been provided, for example, the size of the roof tile on a plane where the solar battery cell holding roof tile disclosed in Patent Document 1 above is provided, is limited. Accordingly, in the case where the roof tile attached to the plane where the solar battery cell holding roof tile is to be provided, and the roof tile already provided at another plane of the roof, are different in size, aesthetic appearance of the roof is significantly deteriorated. In this case, in addition to deterioration in aesthetic appearance, there may be a case where roof tiles are not successfully laid out at the ridge or the like, resulting in a problem of not being able to ensure waterproof performance of the roof and other problems. Accordingly, when the solar battery cell holding roof tile disclosed in Patent Document 1 above is installed at the roof, it is necessary to entirely replace the roof tiles even on a roof plane other than the plane where the solar battery cell holding roof tile is to be provided, in order to use the roof tiles of the same size on the roof planes in all directions, in consideration of aesthetic appearance and performance to be ensured. This results in a problem in cost efficiency and installability.

Furthermore, for a roof tile to which the solar battery cell holding roof tile is adapted, only one type of roof tile creates a small market, and hence it is highly possible that the roof tile is disadvantageous in cost. It is therefore necessary to adapt the solar battery cell holding roof tile to many types of roof tiles. However, it is difficult to adapt the solar battery cell holding roof tile disclosed in Patent Document 1 above, as it is, to such many types of roof tiles, and hence it is necessary to redesign the module shape of the solar battery cell holding roof tile for each of different roof tiles.

The present invention is made to solve the problems as described above, and an object of the present invention is to provide a roof tile-integrated solar battery module applicable to many types of roof tiles.

### Means for Solving the Problems

A roof tile-integrated solar battery module according to the present invention is a roof tile-integrated solar battery module including a solar battery power generating body, and an exterior member accommodating the solar battery power generating body therein and including one exterior plate and the other exterior plate. A concave portion open in a direction to an eaves when the roof tile-integrated solar battery module is provided at a roof, and a fitting portion for connection, for connecting to another roof tile-integrated solar battery module adjacent in a direction intersecting the direction to the eaves, are formed at the one exterior plate. An insertion portion extending in a direction to a ridge when the roof tile-integrated solar battery module is provided at the roof is formed at the other exterior plate.

By doing so, when a plurality of roof tile-integrated solar battery modules are provided in a partially overlapping manner in a direction from the ridge to the eaves when the roof tile-integrated solar battery module is provided at the roof, the insertion portion of another adjacent roof tile-integrated solar battery module is inserted into the concave portion of one roof tile-integrated solar battery module, and thereby the one roof tile-integrated solar battery module and the other adjacent roof tile-integrated solar battery module can be connected. At that time, by adjusting an introduced amount of the insertion portion into the concave portion (a width of an overlap between the roof tile-integrated solar battery modules), it is possible to modify the length of an exposed portion of the roof tile-integrated solar battery module in a direction from the ridge to the eaves (a flow direction) such that the length above matches the length of an exposed portion of the roof tile (a tail width of the roof tile) in the flow direction. As a result, the roof tile-integrated solar battery module according to the present invention can be used for many types of roof tiles each having a different tail width.

The roof tile-integrated solar battery module according to the present invention is a roof tile-integrated solar battery module including a solar battery power generating body, and an exterior member accommodating the solar battery power generating body therein. A concave portion open in the direction to the eaves when the roof tile-integrated solar battery module is provided at the roof, and an insertion portion positioned on a side opposite to the side where the concave portion is positioned and extending in the direction to the ridge side, are formed at the exterior member. Such a roof tile-integrated solar battery module can also be used with many types of roof tiles each having a different tail width.

### Effects of the Invention

As such, according to the present invention, it is possible to implement a roof tile-integrated solar battery module applicable to many types of roof tiles.

### BRIEF DESCRIPTION OF THE DRAWINGS

FIG. 1 is a schematic perspective view showing a first embodiment of a roof tile-integrated solar battery module according to the present invention.

FIG. 2 is a schematic exploded view showing a configuration of the roof tile-integrated solar battery module shown in FIG. 1.

FIG. 3 is a schematic plan view of a solar battery power generating body that forms the roof tile-integrated solar battery module shown in FIG. 2.

FIG. 4 is a schematic perspective view showing a state in which the solar battery power generating body is provided and positioned at a lower metal plate that forms the roof tile-integrated solar battery module according to the present invention.

FIG. 5 is a schematic view showing an upper surface and a side surface of a lower electrode plate provided with the solar battery power generating body shown in FIG. 4.

FIG. 6 is a schematic cross-sectional view taken along a line VI-VI in FIG. 5.

FIG. 7 is a schematic view showing an upper surface and a side surface of an upper metal plate that forms the roof tile-integrated solar battery module shown in FIG. 2.

FIG. 8 is a schematic cross-sectional view taken along a line VIII-VIII in FIG. 1.

FIG. 9 is a schematic plan view of a roof provided with a roof tile-integrated solar battery module 4, which is shown in FIG. 1 and according to the present invention.

FIG. 10 is a schematic cross-sectional view for describing how the roof tile-integrated solar battery modules are connected in a horizontal direction when the roof tile-integrated solar battery modules, which are shown in FIG. 1 and according to the present invention, are provided at the roof.

FIG. 11 is a schematic cross-sectional view for describing how the roof tile-integrated solar battery modules are connected in a flow direction from a ridge side to an eaves side when the roof tile-integrated solar battery modules according to the present invention are provided at the roof.

FIG. 12 is a schematic perspective view for describing a connected portion of the roof tile-integrated solar battery module according to the present invention, with a generally-used roof tile on the eaves side.

FIG. 13 is a schematic view showing the shape of a front surface and a side surface of an eaves edge cover used in the connected portion shown in FIG. 12.

FIG. 14 is a schematic plan view showing a boundary portion between the roof tile-integrated solar battery module and the conventional roof tile in the case where the roof tile-integrated solar battery module according to the present invention is provided at the roof.

FIG. 15 is a schematic perspective view showing a connected portion of the roof tile-integrated solar battery module according to the present invention, with the generally-used roof tile on the ridge side.

FIG. 16 is a schematic perspective view showing a first modification of the first embodiment of the roof tile-integrated solar battery module according to the present invention.

FIG. 17 is a schematic perspective view showing a second modification of the first embodiment of the roof tile-integrated solar battery module according to the present invention.

FIG. 18 is a schematic plan view of an upper metal plate that forms the second embodiment of the roof tile-integrated solar battery module according to the present invention.

### DESCRIPTION OF THE REFERENCE SIGNS

1 solar battery cell, 2 wiring material, 3 solar battery power generating body, 4 roof tile-integrated solar battery module, 6 window portion, 11 lower metal plate, 11c guide, 12 eaves side metal plate, 13 upper metal plate, 14 positioning convex portion, 15a, 15b convex portion, 16a-16f bent portion, 17 colored layer, 18 overlap portion, 19 underlap portion, 20, 35, 36 shock-absorbing material, 21 roof, 22, 23 roof tile, 25 eaves edge cover, 26 fixing foot portion, 27 ridge side cover, 28 insertion portion, 29 corrugated portion, 30 roofboard, 31 roof base material, 32 roof tile bar, 33 screw, 41 upper metal plate insertion portion, 42 eaves side insertion portion, 45 design-formed portion.

### BEST MODES FOR CARRYING OUT THE INVENTION

The embodiments of the present invention will hereinafter be described based on the drawings. The same or corresponding portions in the drawings below are denoted by the same reference numbers, and the description thereof will not be repeated.

### First Embodiment

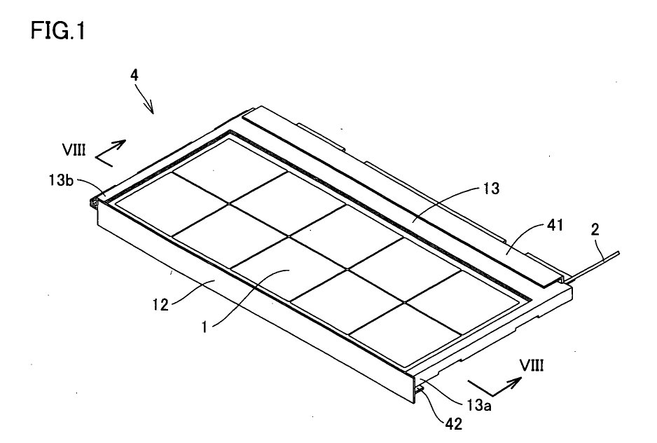

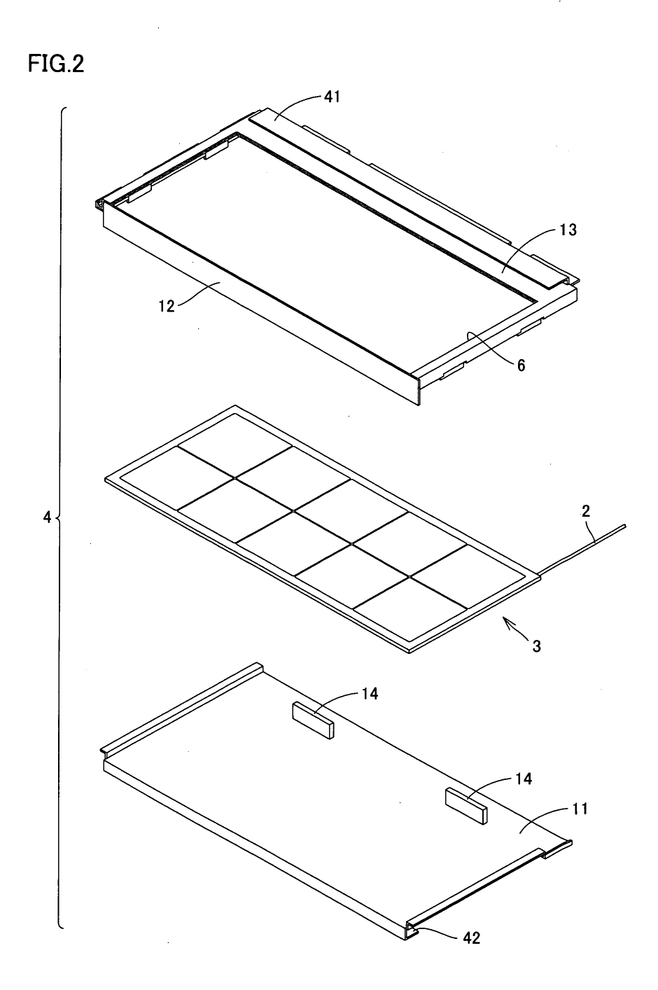

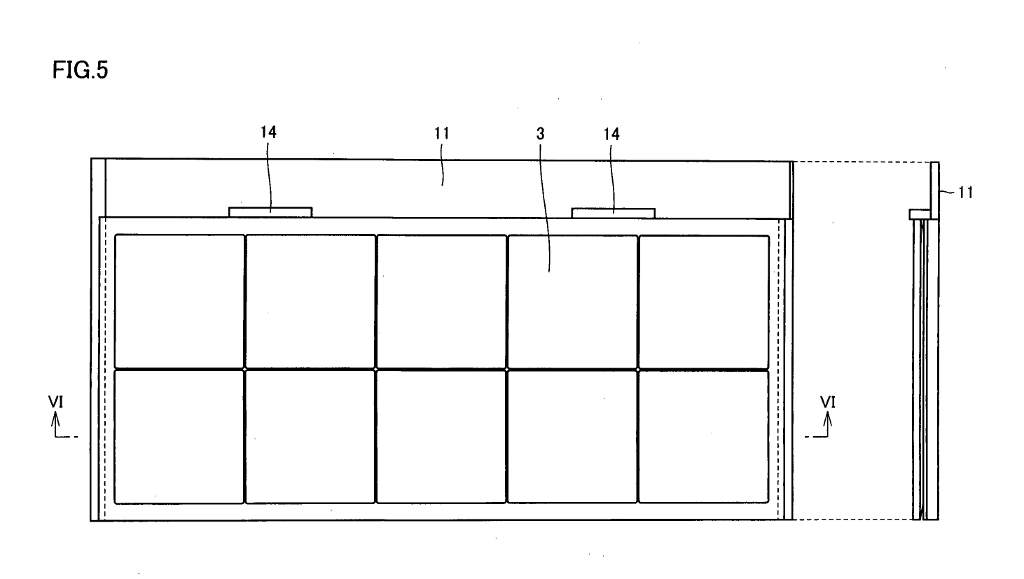

Referring to FIGS. 1-8, a roof tile-integrated solar battery module according to the present invention will be described. As shown in FIGS. 1 and 2, a roof tile-integrated solar battery module 4 according to the present invention has a structure in which a solar battery power generating body 3 is held between an upper metal plate 13 and a lower metal plate 11. Specifically, upper metal plate 13 is placed to cover an upper surface of solar battery power generating body 3. Upper metal plate 13 has an eaves side metal plate 12 fixed thereto with a screw. A wiring material 2 is connected to solar battery power generating body 3. Wiring material 2 is placed to extend to the outside of an exterior member including upper metal plate 13 and lower metal plate 11. Lower metal plate 11 is placed under solar battery power generating body 3. Upper metal plate 13 has an upper metal plate insertion portion 41 formed on its upper surface. Upper metal plate insertion portion 41 may be formed of a material identical to that of upper metal plate 13, or a material different from that of upper metal plate 13. Lower metal plate 11 has an eaves side insertion portion 42 formed at its end portion. Eaves side insertion portion 42 may be formed by processing a part of lower metal plate 11, or by bonding another member to lower metal plate 11. Upper metal plate insertion portion 41 and eaves side insertion portion 42 are used for connecting roof tile-integrated solar battery modules 4 each other when roof tile-integrated solar battery modules 4 are attached to a roof.

By bending a prescribed portion in a peripheral portion of upper metal plate 13 as described below, allowing the prescribed portion to wrap around an end portion of lower metal plate 11 to reach the lower side thereof, and fixing the prescribed portion, upper metal plate 13 and lower metal plate 11 are connected and fixed. As such, it is possible to form roof tile-integrated solar battery module 4 in which solar battery power generating body 3 is held inside the exterior member made of upper metal plate 13 and lower metal plate 11. The structure of roof tile-integrated solar battery module 4 will now be described in further detail.

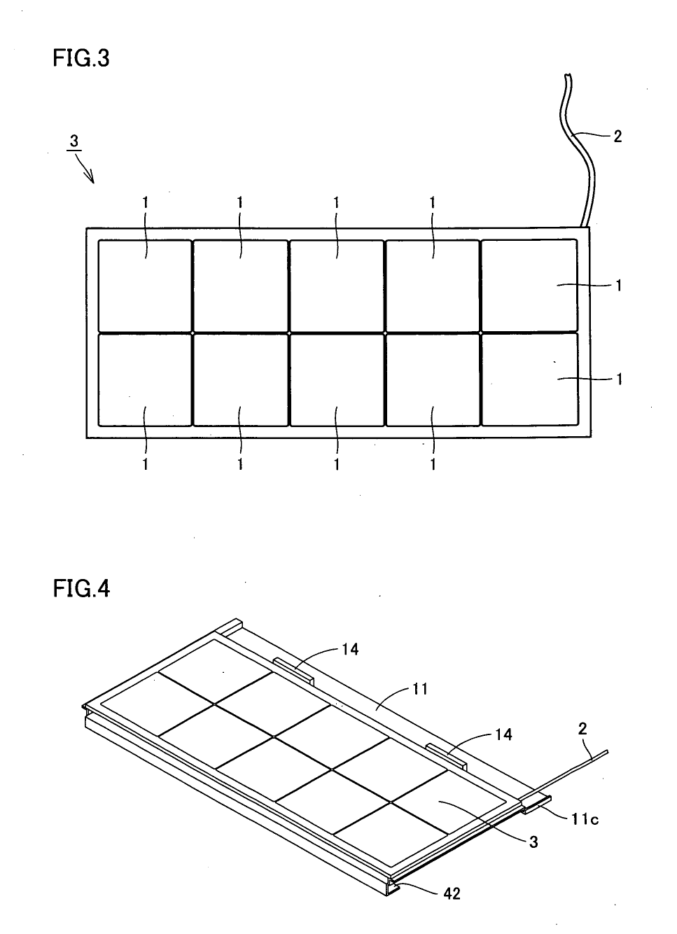

As shown in FIG. 3, solar battery power generating body 3, which forms roof tile-integrated solar battery module 4, has a shape optimally designed based on the shape of solar battery cell, and includes a cell array in which a required number of solar battery cells 1 are electrically connected in series, a glass material, and a protective back film. The cell array of solar battery cell 1 is sandwiched by a filling material, and the glass material is placed on a front side serving as a light-receptive surface of solar battery cells 1 that form the cell array. The backside of the cell array, which is opposite to the front side, is laminated with the protective back film. For the filling material, an EVA resin (ethylene-vinyl acetate copolymerized resin), for example, may be used. Wiring material 2 is connected to solar battery power generating body 3, for electrically connecting a required number of roof tile-integrated solar battery modules 4 (see FIG. 1) in series.

Next, FIGS. 4-6 show a state in which solar battery power generating body 3 is positioned and placed on lower metal plate 11. Two positioning convex portions 14 for positioning solar battery power generating body 3 are formed at lower metal plate 11. By pressing one side of solar battery power generating body 3 against positioning convex portion 14 for alignment, it is possible to position solar battery power generating body 3 with respect to lower metal plate 11. For the material that forms lower metal plate 11, a steel sheet such as soft steel or stainless steel, an aluminum sheet or the like may be used.

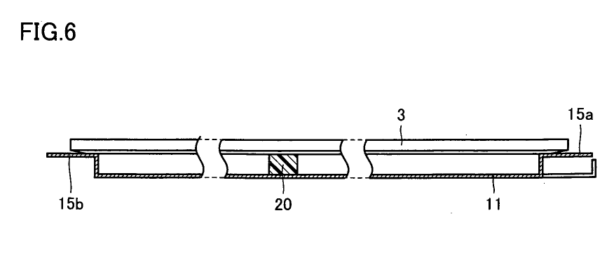

Furthermore, as shown in FIG. 6, convex portions 15a, 15b are formed at both ends of lower metal plate 11. Solar battery power generating body 3 is placed on convex portions 15a, 15b, with its ends brought into contact with convex portions 15a, 15b. At lower metal plate 11, a guide 11c for leading to outside wiring material 2 of solar battery power generating body 3 is formed. Guide 11c is formed such that a part of the end portion where convex portion 15a is formed at lower metal plate 11, which part extends as it is to the periphery of the end of the end portion without forming convex portion 15a, is bent to allow only the end portion to stand in an approximately perpendicular direction.

As can also be seen from FIG. 6, convex portions 15a, 15b described above exist between solar battery power generating body 3 and lower metal plate 11, and hence a cavity is formed. In the cavity, a shock-absorbing material 20 is placed. For the material that forms shock-absorbing material 20, a foamed EPDM (ethylene propylene diene methylene linkage resin) may be used. Shock-absorbing material 20 may be placed at two or three positions in a single roof tile-integrated solar battery module 4 (see FIG. 1).

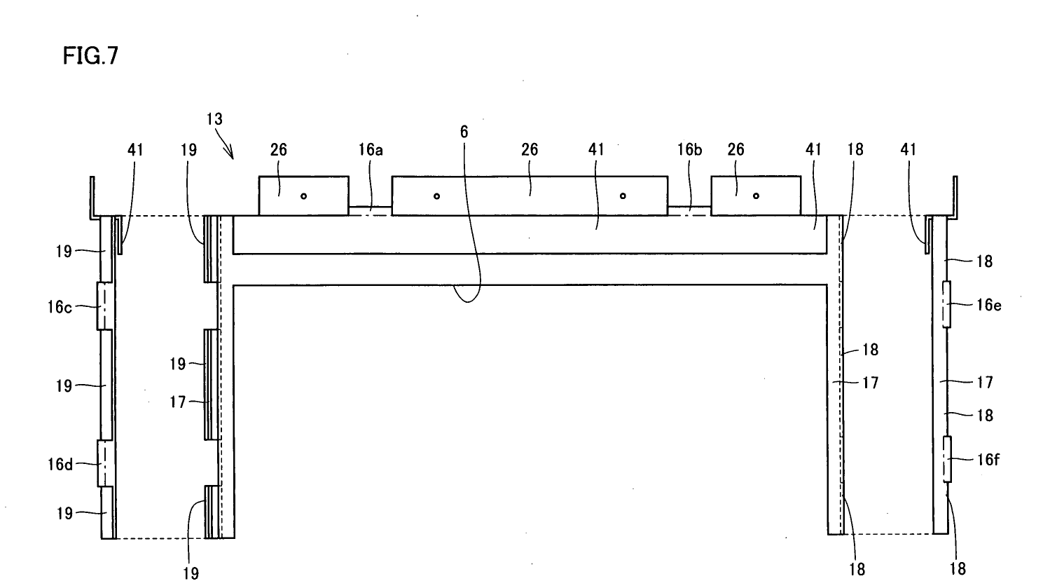

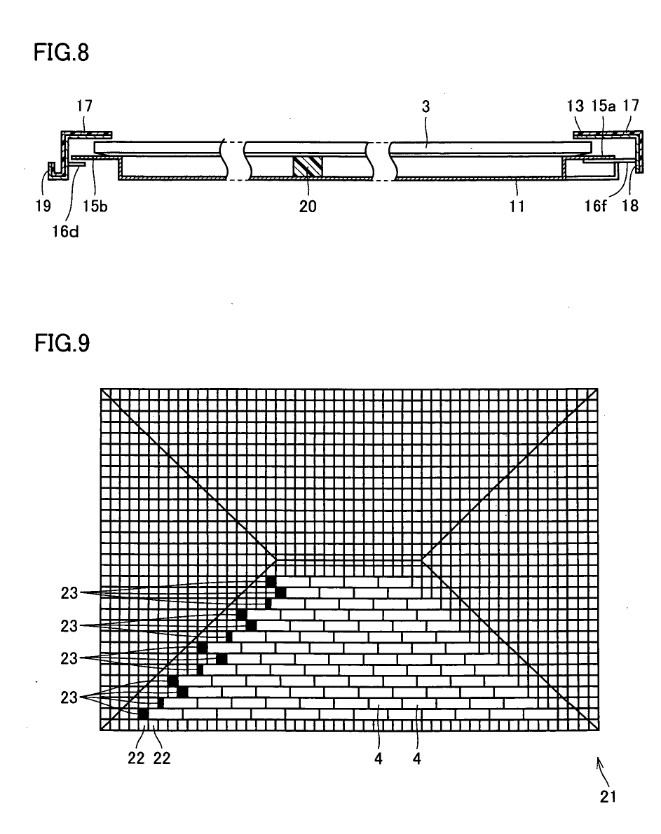

As shown in FIGS. 4-6, solar battery power generating body 3 is placed on lower metal plate 11, and then solar battery power generating body 3 is covered with upper metal plate 13 shown in FIGS. 7 and 8. As shown in FIG. 7, a window portion 6 is formed at upper metal plate 13, for exposing the light-receptive surface of solar battery power generating body 3. Furthermore, an upper metal plate insertion portion 41 and a fixing foot portion 26 are also formed on a ridge side of upper metal plate 13 when roof tile-integrated solar battery module 4 (see FIG. 1) is provided at the roof. Bent portions 16a, 16b for connecting upper metal plate 13 to lower metal plate 11 are formed between fixing foot portions 26 on the eaves side of upper metal plate 13.

Furthermore, an underlap portion 19 and an overlap portion 18 for forming a coupled portion with adjacent roof tile-integrated solar battery module 4 are formed at upper metal plate 13 in a horizontal direction that intersects a flow direction from the ridge side to the eaves side when roof tile-integrated solar battery module 4 is provided at the roof A plurality of underlap portions 19 and overlap portions 18 are provided, and bent portions 16c-16f for connecting and fixing upper metal plate 13 to lower metal plate 11 are formed between underlap portions 19 and between overlap portions 18.

As shown in FIG. 8, each of bent portions 16a-16f described above is bent such that the bent portion wraps around an end portion of lower metal plate 11 (e.g. convex portions 15a, 15b located at the both ends of lower metal plate 11 in FIG. 8) to reach the lower side thereof. As such, lower metal plate 11 and upper metal plate 13 are connected and fixed, with solar battery power generating body 3 held therein.

As can be seen from FIG. 8 as well, a colored layer 17 having a prescribed color or pattern is formed at the surface of upper metal plate 13. For colored layer 17, a paint layer formed by the application of generally-used paint, a plated layer formed by a plating method or the like may be used. The color of colored layer 17 is adjusted to match the color of a roof tile used with roof tile-integrated solar battery module 4, and thereby aesthetic appearance of the roof can be maintained.

Referring to FIGS. 9-15, a method of installing the roof tile-integrated solar battery module, which is shown in FIG. 1 and according to the present invention, will now be described.

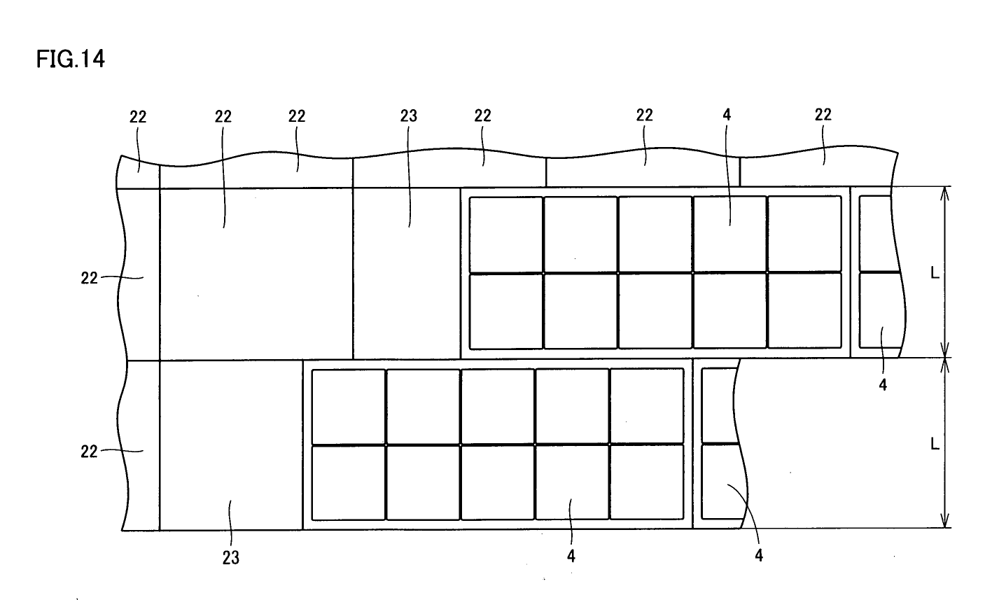

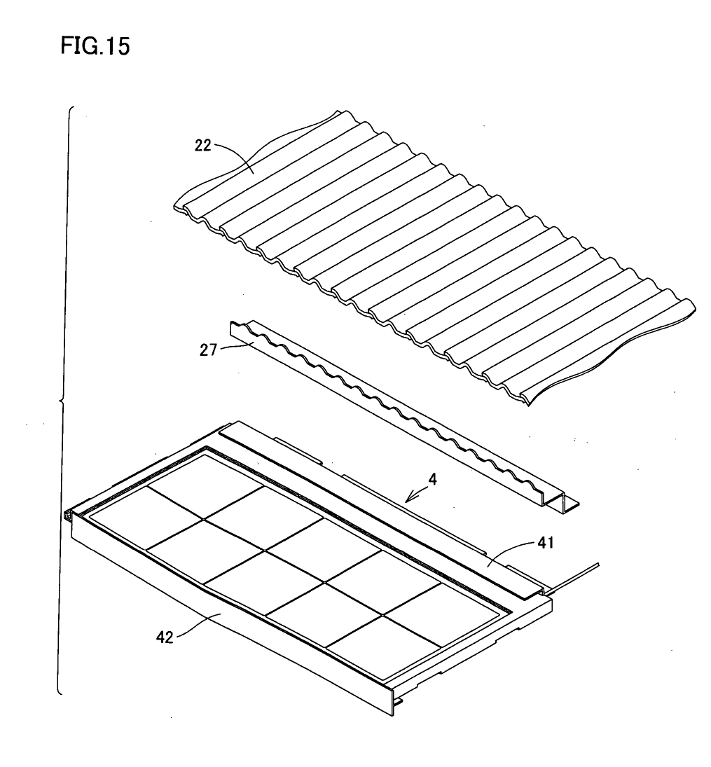

FIG. 9 shows an example of installation in the case where a part of roof tiles 22 provided at roof 21 are replaced with roof tile-integrated solar battery modules 4 according to the present invention in one plane of roof 21. As described later, a length of an exposed portion (tail width L (see FIG. 14)) in the direction from the ridge side to the eaves side of the roof (the flow direction) in roof tile-integrated solar battery module 4 according the present invention is adjusted to be approximately equal to a tail width of roof tile 22. A width of roof tile-integrated solar battery module 4 in a horizontal direction of roof tile-integrated solar battery module 4 (a direction intersecting the flow direction from the ridge side to the eaves side of roof 21) is different from a width of roof tile 22. Therefore, at the end portion, in the horizontal direction, of an area where roof tile-integrated solar battery module 4 is provided, a gap may be formed between adjacent roof tile 22 and roof tile-integrated solar battery module 4. In this case, a roof tile 23 whose end portion has its shape processed is placed to fill the gap, and thereby water or the like is prevented from leaking into a building from this gap.

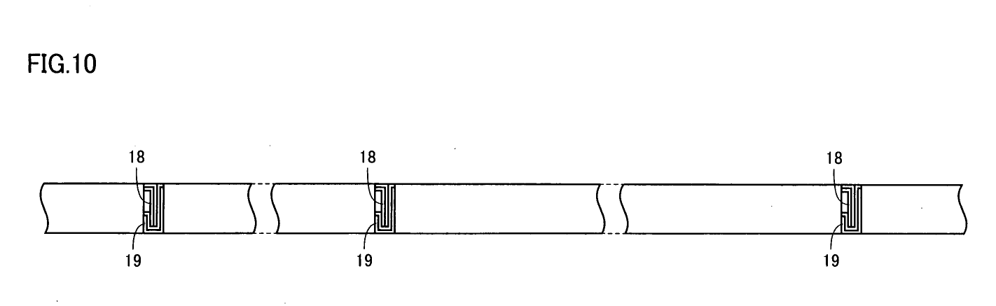

As to the horizontal direction of roof tile-integrated solar battery module 4 described above, underlap portion 19 of one of adjacent roof tile-integrated solar battery modules 4, and overlap portion 18, which faces underlap portion 19 above, of another of adjacent roof tile-integrated solar battery modules 4 are placed to engage with each other, as shown in FIG. 10. As such, roof tile-integrated solar battery modules 4 are coupled to each other in the horizontal direction.

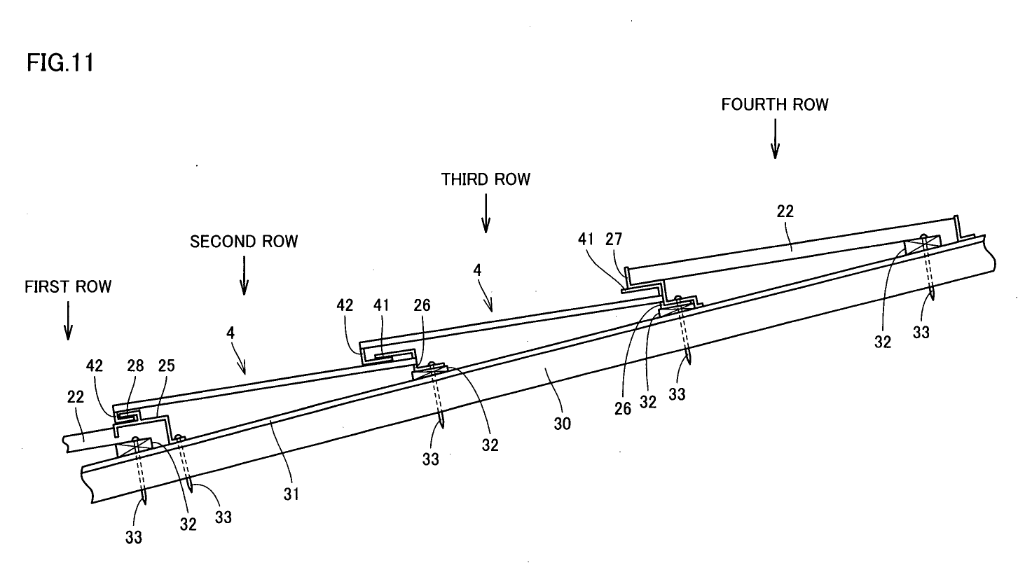

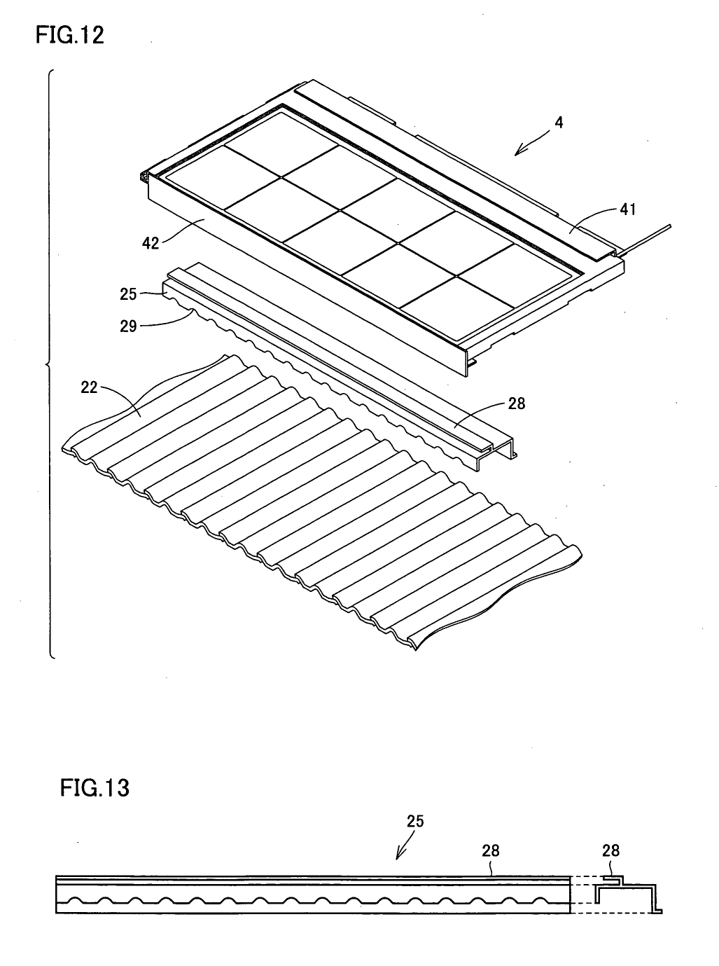

As to the roof where roof tile 22 and roof tile-integrated solar battery module 4 are provided, a roof base material 31 is applied on roofboard 30 that forms the roof, as shown in FIG. 11. On roof base material 31, a roof tile bar 32 for fixing roof tile 22 and roof tile-integrated solar battery module 4 is mounted.

As a method of installing roof tile 22 and roof tile-integrated solar battery module 4 at the roof, roof tiles 22 or roof tile-integrated solar battery modules 4 are successively provided from the eaves side to the ridge side. Specifically, all the roof tiles 22 for a first row of the eaves edge side are initially provided. Roof tile 22 is fixed to the roof by fixing a fixed portion provided at the ridge side of roof tile 22 to roof base material 31 and roofboard 30 with a screw 33. For roof tile 22 to be connected to roof tile-integrated solar battery module 4 that is to be provided in a second row, an eaves edge cover 25 as shown in FIGS. 12 and 13 is connected thereto on its ridge side.

Roof tiles and roof tile-integrated solar battery modules 4 are then provided in a second row. Specifically, after a prescribed number of roof tiles for the second row are provided at the roof, roof tile-integrated solar battery module 4 is placed and fixed adjacently to the roof tiles. At that time, for roof tile 22 in the first row, on the ridge side of which roof tile-integrated solar battery module 4 is placed, eaves edge cover 25 as shown in FIGS. 12 and 13 is fixed thereto on its ridge side.

As shown in FIGS. 12 and 13, a surface shape of a lower portion of eaves edge cover 25 is a corrugated shape that conforms to a surface shape of an upper portion of roof tile 22 in the first row. In other words, a corrugated portion 29 (see FIG. 12) having a corrugated shape is formed at eaves edge cover 25. An insertion portion 28 to which eaves side insertion portion 42 of roof tile-integrated solar battery module 4 is inserted is also formed at eaves edge cover 25. In the case where roof tile-integrated solar battery module 4 for the second row is provided, eaves side insertion portion 42 of roof tile-integrated solar battery module 4 is inserted (fitted) into insertion portion 28 of eaves edge cover 25, as shown in FIG. 11. Furthermore, fixing foot portion 26 provided on the ridge side of upper metal plate 13 of roof tile-integrated solar battery module 4 is fixed to roofboard 30 and roof base material 31 with a screw 33. Screw 33 is screwed into roof base material 31 and roofboard 30 through roof tile bar 32 provided on roof base material 31. As such, roof tile-integrated solar battery module 4 for the second row is fixed to the roof.

Another roof tile-integrated solar battery module 4 is then fixed to the roof such that it is adjacent to roof tile-integrated solar battery module 4 that has been fixed to the roof. At that time, as shown in FIG. 10, the other roof tile-integrated solar battery modules 4 is placed such that underlap portion 19 and overlap portion 18 in the horizontal direction of the adjacent two roof tile-integrated solar battery modules 4 overlap. For the other roof tile-integrated solar battery module 4 described above, eaves side insertion portion 42 thereof is inserted into insertion portion 28 of eaves edge cover 25 provided on the ridge side of roof tile 22 in the first row, as in the case of roof tile-integrated solar battery module 4. At that time, an introduced amount (an inserted depth) of eaves side insertion portion 42 of roof tile-integrated solar battery module 4 into insertion portion 28 of eaves edge cover 25 is adjusted such that a position of the end portion of roof tile 22 in the second row on the eaves side and a position of the end portion of roof tile-integrated solar battery module 4 on the eaves side match each other. Fixing foot portion 26 positioned on the ridge side of the other roof tile-integrated solar battery module described above is fixed to roof tile bar 32, roof base material 31 and roofboard 30 with screw 33 being screwed thereinto. As such, the other roof tile-integrated solar battery module 4 above is fixed to the roof.

Such a procedure is successively repeated, and thereby it is possible to install roof tile-integrated solar battery modules 4 in the second row. When roof tile-integrated solar battery modules 4 are provided at the roof, wiring materials 2 extending outwardly from roof tile-integrated solar battery modules 4 are connected to each other, in order to electrically connect roof tile-integrated solar battery modules 4 each other.

After a prescribed number of roof tile-integrated solar battery modules 4 for the second row are completely provided, generally-used roof tile 22 (see FIG. 9) is further placed adjacently to roof tile-integrated solar battery modules 4. At that time, when the end portion of roof tile-integrated solar battery module 4 and the end portion of roof tile 22 in the first row are misaligned, it is preferable to use a roof tile 23 (see FIG. 9), whose end portion is processed as described above, to fill a gap in the misaligned portion. As such, roof tile 22 and roof tile-integrated solar battery module 4 for the second row are provided at the roof.

As shown in FIG. 11, roof tile-integrated solar battery module for a third row is also provided in a manner similar to that in the case where roof tile-integrated solar battery module 4 for the second row is provided. Specifically, after a prescribed number of roof tiles 22 are provided in the third row, roof tile-integrated solar battery module 4 for the third row is provided adjacently to roof tile 22. At that time, eaves side insertion portion 42 positioned on the eaves side of roof tile-integrated solar battery module 4 in the third row is inserted (fitted) into upper metal plate insertion portion 41 of roof tile-integrated solar battery module 4 in the second row. At the same time, fixing foot portion 26 positioned on the ridge side of roof tile-integrated solar battery module 4 in the third row is fixed to roof tile bar 32, roof base material 31 and roofboard 30 with screw 33, as in the case of roof tile-integrated solar battery module 4 in the second row. At that time, an introduced amount (an inserted depth) of eaves side insertion portion 42 of roof tile-integrated solar battery module 4 in the third row into upper metal plate insertion portion 41 of roof tile-integrated solar battery module 4 in the second row is adjusted such that a position of the end portion on the eaves side of the generally-used roof tile 22 provided in the third row and a position of the end portion on the eaves side of roof tile-integrated solar battery module 4 in the third row match each other. As a result, in the second row, tail width L (see FIG. 14) of roof tile 22 can be made approximately equal to the tail width of roof tile-integrated solar battery module 4. In this state, roof tile-integrated solar battery module 4 is fixed to the roof with screw 33.

As in the case where roof tile-integrated solar battery module 4 in the second row is provided, roof tile-integrated solar battery modules 4 for the third row are successively provided at the roof and fixed thereto such that underlap portion 19 and overlap portion 18 in the horizontal direction of adjacent roof tile-integrated solar battery modules 4 overlap each other. The same procedure is repeated until an intended number of roof tile-integrated solar battery modules 4 for the third row are completely provided.

After a prescribed number of roof tile-integrated solar battery modules 4 for the third row are completely provided, generally-used roof tile 22 (see FIG. 9) is further placed adjacently to roof tile-integrated solar battery modules 4, if necessary. At that time, if the end portion of roof tile-integrated solar battery module 4 and the end portion of roof tile 22 on the first row are misaligned, it is preferable to use a roof tile 23 (see FIG. 9), whose end portion is processed as described above, to fill a gap in the misaligned portion. As such, roof tile 22 and roof tile-integrated solar battery module 4 for the third row are provided at the roof.

As such, an introduced amount (an inserted depth), namely, a length of an overlap between upper metal plate insertion portion 41 of roof tile-integrated solar battery module 4 in the second row and eaves side insertion portion 42 of another roof tile-integrated solar battery module 4 positioned in the third row (adjacent to roof tile-integrated solar battery module 4 in the second row in a direction to the ridge), can be adjusted such that the tail width of roof tile-integrated solar battery module 4 matches tail width L of roof tile 22 (see FIG. 14). It is therefore possible to easily apply roof tile-integrated solar battery module 4 according to the present invention to various roof tiles 22 having different sizes. In the case where roof tile-integrated solar battery module 4 is further placed in the fourth, fifth and more rows, a procedure similar to that for providing roof tile-integrated solar battery module 4 in the third row, as described above, is performed.

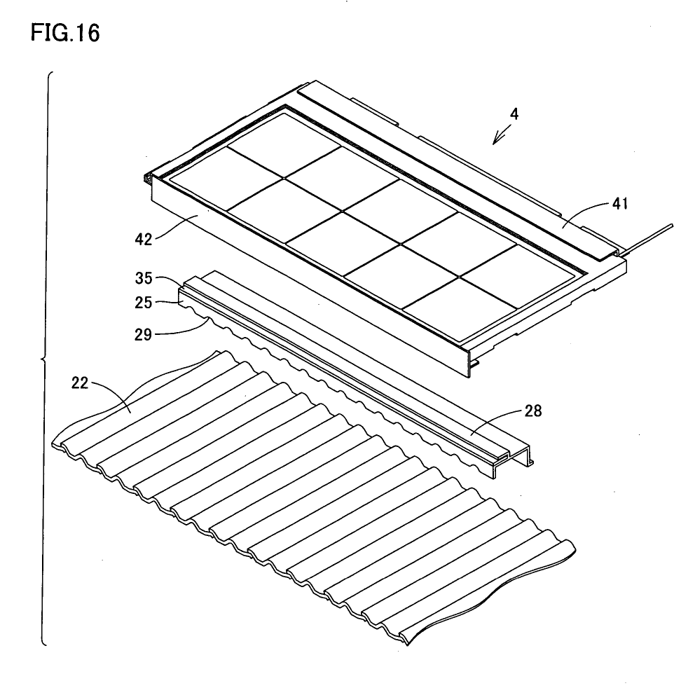

As shown in FIG. 11, roof tile 22 for the fourth row is fixed on the roof FIG. 11 shows the case where generally-used roof tile 22 is placed on the ridge side of roof tile-integrated solar battery module 4 in the third row. In other words, roof tile-integrated solar battery module 4 in the third row shown in FIG. 11 is a roof tile-integrated solar battery module in the last row. In this case, when roof tile-integrated solar battery module 4 for the third row, namely, the last row, is fixed, a ridge side cover 27 shown in FIG. 15 and fixing foot portion 26 are together fixed to the roof with screw 33. An upper end portion of ridge side cover 27 has a corrugated shape that conforms to a bottom surface shape of generally-used roof tile 22 provided in the fourth row. Therefore, when generally-used roof tile 22, as the fourth row, is placed on the ridge side of roof tile-integrated solar battery module 4 in the third row in a partially overlapping manner, as shown in FIG. 11, ridge side cover 27 and roof tile 22 are brought into intimate contact. Roof tile 22 in the fourth row has its ridge side fixed to the roof with screw 33, as in roof tile 22 in the first row. As such, roof tile 22 for the fourth row is fixed to the roof. Roof tiles 22 for the fifth and more rows are fixed to the roof with a generally-used method, and thereby it is possible to implement a roof where roof tiles 22 and roof tile-integrated solar battery modules 4 are provided.

A maintenance method in the case where the provided roof tile-integrated solar battery module 4 is locally broken (e.g. where solar battery power generating body 3 is broken) will now be described. Specifically, a broken part (solar battery power generating body 3) can be replaced in the following method in the broken roof tile-integrated solar battery module 4.

Initially, roof tile-integrated solar battery module 4 whose solar battery power generating body 3 should be replaced is identified. As to roof tile-integrated solar battery module 4 identified as a target for replacement, eaves side metal plate 12 (see FIG. 2) provided at upper metal plate 13 (see FIG. 2) is removed from upper metal plate 13 by removing a screw with which eaves side metal plate 12 is fixed. As a result, an opening for removing solar battery power generating body 3 from an inside of roof tile-integrated solar battery module 4 (an opening that appears by removing eaves side metal plate 12) is formed on the eaves side of roof tile-integrated solar battery module 4. Through this opening, solar battery power generating body 3, which is placed between upper metal plate 13 and lower metal plate 11 (see FIG. 2), is extracted. The connection in a connected portion between wiring material 2 connected to removed solar battery power generating body 3 and wiring material 2 connected to another adjacent roof tile-integrated solar battery module is then terminated. As such, solar battery power generating body 3 can be removed from roof tile-integrated solar battery module 4.

Next, a wiring material of new solar battery power generating body 3 is connected to wiring material 2 of the other adjacent roof tile-integrated solar battery module 4 described above. Furthermore, new solar battery power generating body 3 is inserted through the above-described opening and placed at a prescribed position inside the exterior member formed of lower metal plate 11 and upper metal plate 13. Eaves side metal plate 12, which has been removed previously, is fixed again to upper metal plate 13 with the screw. As such, solar battery power generating body 3 can be replaced without removing roof tile-integrated solar battery module 4 from the roof.

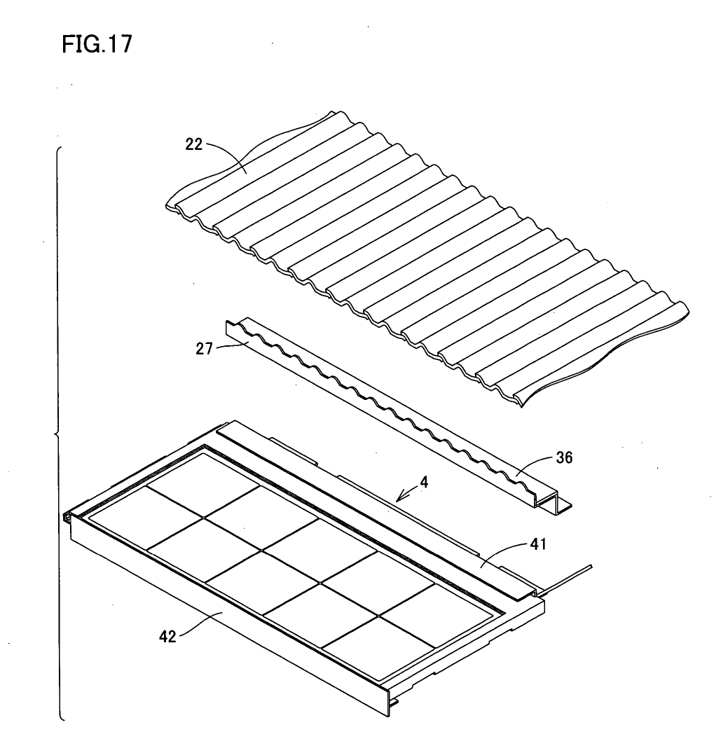

Referring to FIG. 16, a first modification of the first embodiment of the roof tile-integrated solar battery module according to the present invention will be described. It is noted that FIG. 16 corresponds to FIG. 12.

Roof tile-integrated solar battery module 4 shown in FIG. 16 is basically similar to roof tile-integrated solar battery module 4 shown in FIGS. 1-15, except for a structure of eaves edge cover 25 used when roof tile-integrated solar battery module 4 is installed at the roof. Specifically, eaves edge cover 25 used for roof tile-integrated solar battery module 4 shown in FIG. 16 is provided with a shock-absorbing material 35 at its insertion portion 28. Such shock-absorbing material 35 has two functions including waterproof function and shock absorbing function. As a result, it is possible to improve installability of roof tile-integrated solar battery module 4, as well as improve its waterproof performance.

Referring to FIG. 17, a second modification of the first embodiment of roof tile-integrated solar battery module 4 according to the present invention will be described. It is noted that FIG. 17 corresponds to FIG. 15.

Roof tile-integrated solar battery module 4 shown in FIG. 17 has a structure basically similar to that of roof tile-integrated solar battery module 4 shown in FIGS. 1-15, except for a structure of ridge side cover 27 used when roof tile-integrated solar battery module 4 is installed at the roof In other words, ridge side cover 27 shown in FIG. 17 is provided with a shock-absorbing material 36 having waterproof function and shock absorbing function. By doing so, it is also possible to improve installability of roof tile-integrated solar battery module 4 as well as improve its waterproof capability. For the material of shock-absorbing materials 35, 36 described above, a butyl-added, foamed EPDM (ethylene propylene diene methylene linkage resin) or the like may be used.

In roof tile-integrated solar battery module 4 described above, solar battery power generating body 3 has a shape corresponding to that of solar battery cell 1 (see FIG. 3). However, if decrease in efficiency of the solar battery module in solar battery power generating body 3 is acceptable to a certain degree, solar battery power generating body 3 may have a shape that does not match the shape of solar battery cell 1 (i.e., the substrate of solar battery cell 1 may be processed to fit the shape of solar battery power generating body 3).

In the embodiment described above, roof tile-integrated solar battery module 4, which has an exterior member including upper metal plate 13, lower metal plate 11, and eaves side metal plate 12, is shown. However, roof tile-integrated solar battery module 4 may be formed with an exterior member having upper metal plate 13 and lower metal plate 11 formed therein in an integral manner.

### Second Embodiment

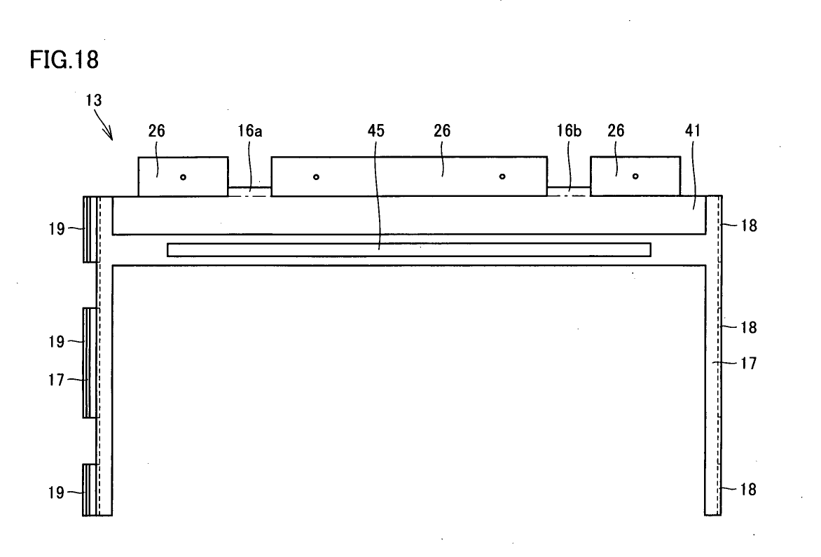

Referring to FIG. 18, a second embodiment of roof tile-integrated solar battery module 4 according to the present invention will be described.

The roof tile-integrated solar battery module using upper metal plate 13 shown in FIG. 18 has a structure basically similar to that of the first embodiment of the roof tile-integrated solar battery module according to the present invention, except that a design-formed portion 45 showing a letter, a prescribed mark, a pattern or the like is placed on a surface of upper metal plate 13. Design-formed portion 45 can be formed by a method such as application of paint, a plating method, or a method of applying a label made of resin and the like. By doing so, it is possible to further improve applicability to design in roof tile-integrated solar battery module 4.

The color of upper metal plate 13 (colored layer 17 (see FIG. 8)) may be modified to any of various colors. The color of colored layer 17 may be set to a color similar to that of the solar battery cell that forms solar battery power generating body 3 (see FIG. 1).

As to the roof tile-integrated solar battery module 4 above, replacement work for replacing solar battery power generating body 3 can be performed by removing eaves side metal plate 12. However, for the method of replacing solar battery power generating body 3, another method may be used. For example, upper metal plate 13 is formed such that it can easily be removed from roof tile-integrated solar battery module 4, and solar battery power generating body 3 may be replaced by removing upper metal plate 13 from roof tile-integrated solar battery module 4 (i.e. from lower metal plate 11).

To summarize the characteristic configuration of the roof tile-integrated solar battery module described above and according to the present invention, roof tile-integrated solar battery module 4 is roof tile-integrated solar battery module 4 including solar battery power generating body 3, and the exterior member accommodating solar battery power generating body 3 therein and including upper metal plate 13 serving as one exterior plate and lower metal plate 11 serving as the other exterior plate. A concave portion (a concave portion formed of upper metal plate insertion portion 41 and the surface of upper metal plate 13) open in the direction to the eaves when roof tile-integrated solar battery module 4 is provided at the roof, and a fitting portion for connection (overlap portion 18 and underlap portion 19), for connecting to another roof tile-integrated solar battery module 4 adjacent in a direction intersecting the direction to the eaves, are formed at upper metal plate 13. Eaves side insertion portion 42 serving as an insertion portion and extending in a direction to the ridge when roof tile-integrated solar battery module 4 is provided at the roof is formed at lower metal plate 11.

From a different point of view, roof tile-integrated solar battery module 4 according to the present invention is roof tile-integrated solar battery module 4 including solar battery power generating body 3, and an exterior member (an exterior member formed of lower metal plate 11, upper metal plate 13, and eaves side metal plate 12) accommodating solar battery power generating body 3 therein. A concave portion (a concave portion formed of upper metal plate insertion portion 41 and the surface of upper metal plate 13) open in the direction to the eaves when roof tile-integrated solar battery module 4 is provided at the roof, and an insertion portion (eaves side insertion portion 42) positioned on a side opposite to the side where the concave portion is positioned and extending in the direction to the ridge side, are formed at the exterior member.

By doing so, in the case where a plurality of roof tile-integrated solar battery modules 4 are provided in a partially overlapping manner in the direction from the ridge to the eaves when roof tile-integrated solar battery modules 4 are provided at the roof (i.e., in the flow direction), the insertion portion (eaves side insertion portion 42) of another roof tile-integrated solar battery module 4 adjacent on the ridge side is inserted into the concave portion of one roof tile-integrated solar battery module 4 (the concave portion formed of upper metal plate insertion portion 41 and the surface of upper metal plate 13), and thereby the one roof tile-integrated solar battery module and the other adjacent roof tile-integrated solar battery module 4 can be connected. At that time, by adjusting an introduced amount of the insertion portion (eaves side insertion portion 42) into the concave portion (the concave portion formed of upper metal plate insertion portion 41 and the surface of upper metal plate 13), (i.e., a width of an overlap between adjacent roof tile-integrated solar battery modules 4), it is possible to modify the length of an exposed portion of roof tile-integrated solar battery module 4 in the flow direction such that the length above matches the length of an exposed portion of roof tile 22 in the flow direction (tail width L of the roof tile (see FIG. 14)). As a result, roof tile-integrated solar battery module 4 according to the present invention can be used for many types of roof tiles 22 different in tail width L. The length of each of upper metal plate insertion portion 42 and eaves side insertion portion 42 in the flow direction is set such that tail width L can be adapted to a numerical range as wide as possible, as long as sufficient strength can be maintained and solar irradiation to solar battery power generating body 3 is not blocked, when roof tile-integrated solar battery module 4 is provided at the roof.

In the above-described roof tile-integrated solar battery module, the exterior member (the exterior member formed of lower metal plate 11, upper metal plate 13, and eaves side metal plate 12) is made of metal. In this case, fire resistance of roof tile-integrated solar battery module 4 can be improved, and hence it is possible to use roof tile-integrated solar battery module 4 as a fire retardant.

In roof tile-integrated solar battery module 4 above, upper metal plate 13 serving as the one exterior plate includes bent portions 16a-16f (see FIG. 7) each serving as a projection portion. The projection portion connects upper metal plate 13 and lower metal plate 11 by being bent to grasp an end portion of lower metal plate 11 serving as the other exterior member.

In this case, by bending bent portions 16a-16f of upper metal plate 13, upper metal plate 13 and lower metal plate 11 can easily be coupled. It is therefore possible to simplify the procedure for manufacturing roof tile-integrated solar battery module 4, when compared with the case where upper metal plate 13 and lower metal plate 11 are coupled with a screw, an adhesive and others.

Since upper metal plate 13 and lower metal plate 11 are coupled without using an adhesive and others, a procedure for dissolving and removing the adhesive is unnecessary when roof tile-integrated solar battery module 4 is recycled. It is therefore possible to easily recycle roof tile-integrated solar battery module 4.

In roof tile-integrated solar battery module 4 described above, bent portions 16c-16f above are formed on the sides of upper metal plate 13 in a direction intersecting the direction to the eaves (i.e. the sides in the horizontal direction where overlap portion 18 and underlap portion 19 are formed).

In roof tile-integrated solar battery module 4 described above, lower metal plate 11 serving as the other exterior plate has convex portions 15a, 15b (see FIG. 8) for supporting solar battery power generating body 3.

In this case, when solar battery power generating body 3 is provided on lower metal plate 11, solar battery power generating body 3 is placed such that a part (an end portion) of the surface of solar battery power generating body 3 is brought into contact with convex portions 15a, 15b. It is thereby possible to prevent the other portion (the central portion) of solar battery power generating body 3 from being in direct contact with lower metal plate 11. Accordingly, during a procedure for producing roof tile-integrated solar battery module 4, and a procedure for installing roof tile-integrated solar battery module 4, it is possible to lower the probability of occurrence of damage to the central portion of the surface of solar battery power generating body 3, for example, the damage being caused by contact with lower metal plate 11.

Roof tile-integrated solar battery module 4 above further includes shock-absorbing material 20 (see FIG. 8) serving as power generating body shock-absorbing member placed between solar battery power generating body 3 and lower metal plate 11 forming the exterior member. In this case, with shock-absorbing material 20, it is possible to further reduce the possibility of contact between the central portion of solar battery power generating body 3 and lower metal plate 11 forming the exterior member. Accordingly, it is possible to further lower the probability of occurrence of damage to the surface of solar battery power generating body 3. A shock-absorbing material serving as a power generating body shock-absorbing member may be placed between upper metal plate 13, which forms the exterior member, and solar battery power generating body 3.

In roof tile-integrated solar battery module 4, solar battery power generating body 3 may include solar battery cell 1 (see FIG. 3). The outer dimension of solar battery power generating body 3 is determined based on the outer dimension of solar battery cell 1. In this case, solar battery cell is not cut in accordance with the dimension of roof tile-integrated solar battery module 4, and the dimension of solar battery power generating body 3 is determined based on the outer dimension of solar battery cell 1. In other words, solar battery power generating body 3 can be utilized as a common part for different sizes of roof tile-integrated solar battery modules 4.

Roof tile-integrated solar battery module 4 above further includes at least one of eaves edge cover 25 (see FIG. 12) serving as an eaves edge cover member for filling a gap between roof tile-integrated solar battery module 4 and roof tile 22 positioned adjacently to the eaves side of roof tile-integrated solar battery module 4, and ridge side cover 27 (see FIG. 15) serving as a ridge side cover member for filling a gap between roof tile-integrated solar battery module 4 and roof tile 22 positioned on the ridge side of roof tile-integrated solar battery module 4, in the state where roof tile-integrated solar battery module 4 is provided at the roof. Each of eaves edge cover 25 and ridge side cover 27 includes a portion having a surface shape that conforms to a surface shape of roof tile 22 (corrugated portion 29 of eaves edge cover 25 or an upper end portion of ridge side cover 27).

In this case, the gap between roof tile-integrated solar battery module 4 and roof tile 22 adjacent thereto is filled with eaves edge cover 25 or ridge side cover 27, and hence it is possible to prevent deterioration in aesthetic appearance of the roof, which deterioration is caused by the gap between roof tile-integrated solar battery module 4 and roof tile 22. By using such eaves edge cover 25 or ridge side cover 27, it is further possible to maintain waterproof performance of the roof at which roof tile-integrated solar battery module 4 is provided, in a preferable manner.

In roof tile-integrated solar battery module 4 above, a shock-absorbing member (shock-absorbing material 35 (see FIG. 16) provided at eaves edge cover 25 or shock-absorbing material 36 (see FIG. 17) provided at ridge side cover 27) having waterproof function may be provided at least one of eaves edge cover 25 and ridge side cover 27. In this case, it is possible to improve waterproof performance of roof tile-integrated solar battery module 4, and improve installability of roof tile-integrated solar battery module 4 as well.

In roof tile-integrated solar battery module 4 above, colored layer 17 (see FIG. 8) is formed at the surface of the exterior member (e.g. upper metal plate 13 forming the exterior member). In this case, by forming colored layer 17 having a color that matches the color of another roof tile 22 in the roof to which roof tile-integrated solar battery module 4 is applied, it is possible to reduce the possibility that aesthetic appearance of the roof at which roof tile-integrated solar battery module 4 is provided, is deteriorated by roof tile-integrated solar battery module 4.

In roof tile-integrated solar battery module 4 above, the shape of each of upper metal plate 13 and lower metal plate 11 is determined such that, in the case where the upper metal plate 13 and lower metal plate 11 are combined, an opening through which solar battery power generating body 3 can be removed is formed on the eaves side when roof tile-integrated solar battery module 4 is provided at the roof. In other words, any convex portion or sidewall that could prevent removal of solar battery power generating body 3 is not formed at upper metal plate 13 on its eaves side. Also at lower metal plate 11, any convex portion or sidewall that could prevent removal of solar battery power generating body 3 is not formed on its eaves side. The exterior member further includes eaves side metal plate 12 (see FIG. 1) blocking the opening described above, and serving as an eaves side exterior plate detachably and attachably provided at upper metal plate 13 and lower metal plate 11 that form the exterior member.

In this case, only solar battery power generating body 3 can easily be replaced, while roof tile-integrated solar battery module 4 is provided at the roof. It is therefore possible to simplify maintenance work for roof tile-integrated solar battery module 4.

Although the present invention has been described and illustrated in detail, it is clearly understood that the same is by way of illustration and example only and is not to be taken by way of limitation, the spirit and scope of the present invention being limited only by the terms of the appended claims.

### INDUSTRIAL APPLICABILITY

The roof tile-integrated solar battery module according to the present invention can be installed in a manner adaptable to various sizes of roof tiles. The same roof tile-integrated solar battery module is utilized for various sizes of roof tiles, and thereby the roof tile-integrated solar battery module is suitable for forming a low-cost solar battery system.

1. A roof tile-integrated solar battery module, comprising a solar battery power generating body, and an exterior member accommodating said solar battery power generating body therein and including one exterior plate and the other exterior plate, wherein
a concave portion open in a direction to an eaves when the roof tile-integrated solar battery module is provided at a roof, and a fitting portion for connection, for connecting to another roof tile-integrated solar battery module adjacent in a direction intersecting said direction to the eaves, are formed at said one exterior plate, and
an insertion portion extending in a direction to a ridge when the roof tile-integrated solar battery module is provided at the roof is formed at said other exterior plate.

2. The roof tile-integrated solar battery module according to claim 1, wherein said one exterior plate includes a projection portion, the projection portion connecting said one exterior plate and said other exterior plate by being bent to grasp an end portion of said other exterior member.

3. The roof tile-integrated solar battery module according to claim 1, wherein said other exterior plate has a convex portion for supporting said solar battery power generating body.

4. The roof tile-integrated solar battery module according to claim 1, further comprising a power generating body shock-absorbing member placed between said solar battery power generating body and said exterior member.

5. The roof tile-integrated solar battery module according to claim 1, wherein
said solar battery power generating body includes a solar battery cell, and
an outer dimension of said solar battery power generating body is determined based on an outer dimension of said solar battery cell.

6. The roof tile-integrated solar battery module according to claim 1, further comprising at least one of an eaves edge cover member for filling a gap between said roof tile-integrated solar battery module and a roof tile positioned adjacently to an eaves side of said roof tile-integrated solar battery module, and a ridge side cover member for filling a gap between said roof tile-integrated solar battery module and a roof tile positioned adjacently to a ridge side of said roof tile-integrated solar battery module, in a state where said roof tile-integrated solar battery module is provided at the roof, wherein
each of said eaves edge cover member and said ridge side cover member has a portion having a surface shape conforming to a surface shape of said roof tile.

7. The roof tile-integrated solar battery module according to claim 6, wherein a shock-absorbing member having waterproof function is provided at least one of said eaves edge cover member and said ridge side cover member.

8. The roof tile-integrated solar battery module according to claim 1, wherein a colored layer is formed at a surface of said exterior member.

9. The roof tile-integrated solar battery module according to claim 1, wherein
a shape of each of said one exterior plate and said other exterior plate is determined such that, when said one exterior plate and said other exterior plate are combined, an opening through which said solar battery power generating body can be removed is formed on a side of said eaves when said roof tile-integrated solar battery module is provided at the roof, and
said exterior member further includes an eaves side exterior plate blocking said opening and detachably and attachably provided to said one exterior plate and said other exterior plate.
